(19) United States
(12) Patent Application Publication
(10) Pub. No.: US 2005/0249435 A1
(43) Pub. Date: Nov. 10, 2005

(54) Apparatuses and methods for rotating an image

(76) Inventors: Barinder Singh Rai, Surrey (CA); George Lyons, Langley (CA); Jimmy Kwok Lap Lai, Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/840,306

(22) Filed: May 6, 2004

(51) Int. Cl. G06K 9/32

(52) U.S. Cl. 382/296

(57) ABSTRACT

A hardware implemented method for rotating an image about a user defined reference point is provided. In this method, the user defined reference point is received and the user defined reference point is capable of being defined outside the image. Subsequently, a position of the image is calculated whereby the position defines a location of the image after rotation about the user defined reference point. An order to fetch one or more image pixels from memory is then calculated. The order defines a rotation of the image after rotation about the user defined reference point. Thereafter, the image pixels are fetched from the memory according to the calculated order. An apparatus and a display controller for rotating the image about the user defined reference point also are described.

### BACKGROUND OF THE INVENTION

1. Field of the Invention

This invention relates generally to computer graphics and, more particularly, to methods and apparatuses for rotating an image on a display screen.

2. Description of the Related Art

In computer graphics, a sprite is an individually animated element in a larger graphic image or set of images. Sprites are frequently part of game technology and many games basically consist of sprites and program instructions for moving the sprites within a graphic background.

One type of animation involves rotating the sprites, and calculations to rotate the sprites are typically done by the software. However, such software calculations for rotating the sprites are computationally complex and, therefore, involve extensive central processing unit (CPU) processing. For example, a typical game can have as many as twenty seven sprites simultaneously being displayed and animated.

As a result, many small, portable devices have problems processing the animation of sprites because these devices typically have limited power, memory, and computing capability. Since these devices are limited in their computing power, processing the sprites may dominate the CPU cycles of these devices and, as a result, dramatically slows down the executed applications.

In view of the foregoing, there is a need to provide apparatuses and methods for reducing the complexity of calculations and CPU processing power required to animate the sprites.

### SUMMARY OF THE INVENTION

Broadly speaking, the present invention fills these needs by providing a method and an apparatus for rotating an image about a user defined reference point. It should be appreciated that the present invention can be implemented in numerous ways, including as a method, a system, or a device. Several inventive embodiments of the present invention are described below.

In accordance with a first aspect of the present invention, a hardware implemented method for rotating an image about a user defined reference point is provided. In this method, the user defined reference point is received and the user defined reference point is capable of being defined outside the image. Subsequently, a position of the image is calculated whereby the position defines a location of the image after rotation about the user defined reference point. An order to fetch one or more image pixels from memory is then calculated. The order defines a rotation of the image after rotation about the user defined reference point. Thereafter, the image pixels are fetched from the memory according to the calculated order.

In accordance with a second aspect of the present invention, a display controller for rotating an image about a user defined reference point is provided. The display controller includes a memory configured to store image pixels and a main display pipe configured to fetch the stored image pixels from the memory. Additionally, a rotation and mirroring circuitry coupled to the main display pipe is configured to calculate the rotation of the image about the user defined reference point. The rotation and mirroring circuitry includes logic for receiving the user defined reference point, logic for calculating a position of the image, and logic for calculating an order to fetch the image pixels from the memory. The calculated position defines a location of the image after rotation about the user defined reference point. Additionally, the calculated order defines a rotation of the image after rotation about the user defined reference point.

In accordance with a third aspect of the present invention, an apparatus for rotating an image about a user defined reference point is provided. The apparatus includes a display controller and a memory configured to store image pixels. Additionally, the apparatus includes a central processing unit that contains instructions to process the user defined reference point and to transmit the user defined reference point to the display controller. The display controller includes circuitry for calculating a position of the image, circuitry for calculating an order to fetch the image pixels from the memory, and circuitry for fetching the image pixels from the memory according to the calculated order. The calculated position defines a location of the image after rotation about the user defined reference point. Additionally, the calculated order defines a rotation of the image after rotation about the user defined reference point. The apparatus also includes a display coupled to the display controller that displays the rotated image.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIGS. 1A and 1B are diagrams of images being rotated about a user defined image point, in accordance with one embodiment of the present invention.

FIG. 2 is a flowchart diagram of a high level overview of a hardware implemented method for rotating an image about a user defined reference point, in accordance with one embodiment of the present invention.

FIGS. 3A, 3B, 3C, 3D, 3E, 3F, 3G, and 3H are simplified schematic diagrams of dimensions used in the calculation of a position of an image after rotation about a user defined reference point, in accordance with one embodiment of the present invention.

FIG. 4 is a simplified diagram illustrating an order of memory addresses being fetched when an image is rotated ninety degrees about a user defined reference point, in accordance with one embodiment of the present invention.

FIGS. 5A, 5B, 5C, 5D, 5E, 5F, 5G, and 5H are simplified schematic diagrams of dimensions used in the calculation of memory addresses to fetch at particular pixel positions to rotate an image, in accordance with one embodiment of the present invention.

FIG. 6 is a simplified schematic diagram of an apparatus for rotating an image about a user defined reference point, in accordance with one embodiment of the present invention.

FIG. 7 is a more detailed schematic diagram of the display controller shown in FIG. 6, in accordance with one embodiment of the present invention.

### DETAILED DESCRIPTION OF THE PREFERRED EMBODIMENTS

An invention is described for methods and apparatuses for rotating an image about a user defined reference point. It will be obvious, however, to one skilled in the art, that the present invention may be practiced without some or all of these specific details. In other instances, well known process operations have not been described in detail in order not to unnecessarily obscure the present invention.

The embodiments described herein provide hardware implemented methods and a display controller for rotating the image about the user defined reference point. As will be explained in more detail below, to rotate the image, the position of the image and an order to fetch image pixels from memory are calculated. Subsequently, the image is displayed at the calculated position and the image pixels are fetched from the memory according to the calculated order. The order in which the image pixels are fetched defines a rotation of the image.

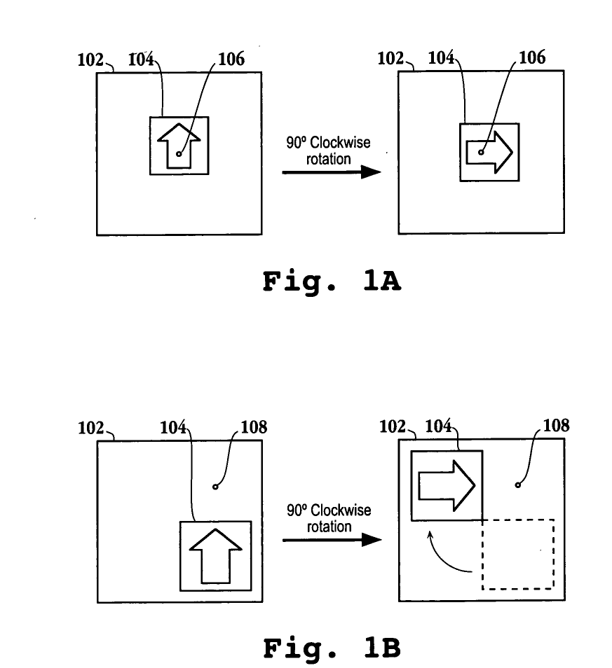

FIGS. 1A and 1B are diagrams of images being rotated about a user defined image point, in accordance with one embodiment of the present invention. As shown in FIG. 1A, display 102 shows image region 104. Image region 104 is a portion of a larger image (e.g., display 102). In one embodiment, image region 104 is a sprite. A sprite can be an animated graphic image in a larger image. As described herein, image region 104 may alternatively be defined as an image and, as such, the terms may be used interchangeably. Here, image region 104 is an arrow pointing upwards and a user wants to rotate the image region ninety degrees clockwise about reference point 106. Reference point 106 is located at the middle of image region 104. As a result, a ninety degrees clockwise rotation about reference point 106 results in the arrow pointing towards the right. The details for performing the rotation are provided herein.

It should be appreciated that reference point 106 may be defined anywhere within display 102. In one embodiment, as shown in FIG. 1A, reference point 106 is located within image region 104. In another embodiment, as shown in FIG. 1B, reference point 106 is located outside image region 104. FIG. 1B shows image region 104 including an arrow pointing upwards within display 102 and the image region is located at a bottom right hand corner of the display. The user wants to rotate the image region ninety degrees clockwise about reference point 108. In this case, reference point 108 is located outside of image region 104. Specifically, reference point 108 is located above image region 104. A ninety degrees clockwise rotation about reference point 108 results in image region 104 and the arrow therein pointing towards the right. Additionally, a position of image region 104 changes from the bottom right hand corner of display 102 to a top left hand corner of the display.

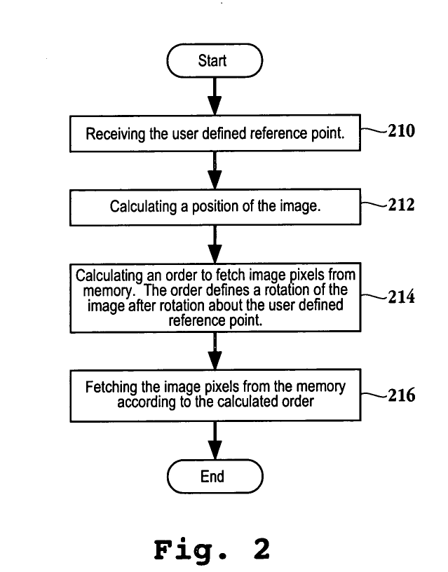

As illustrated in FIGS. 1A and 1B, the rotation of image region 104 about user defined reference points 106, 108 may be defined by (1) a rotation of the image region and (2) a change in position of the image region. FIG. 2 is a flowchart diagram of a high level overview of a hardware implemented method for rotating an image about a user defined reference point, in accordance with one embodiment of the present invention. Starting in operation 210, a user defined reference point is received. As discussed above, the user defined reference point may be defined outside the image. Subsequently, a position of the image is calculated in operation 212. The position defines a location of the image after rotation about the user defined reference point. Thereafter, an order to fetch image pixels from memory is calculated in operation 214. The order defines a rotation of the image after the image is rotated about the user defined reference point. As will be explained in more detail below, in one embodiment, the order is a calculated association of a pixel position within the image with a memory address of an image pixel stored in memory. Thereafter, in operation 216, the image pixels are fetched from the memory according to the calculated order.

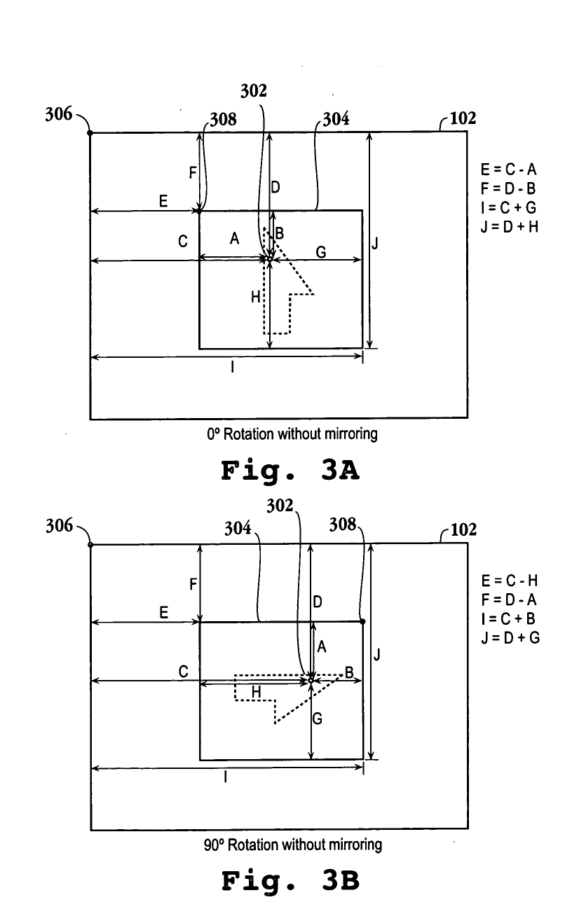

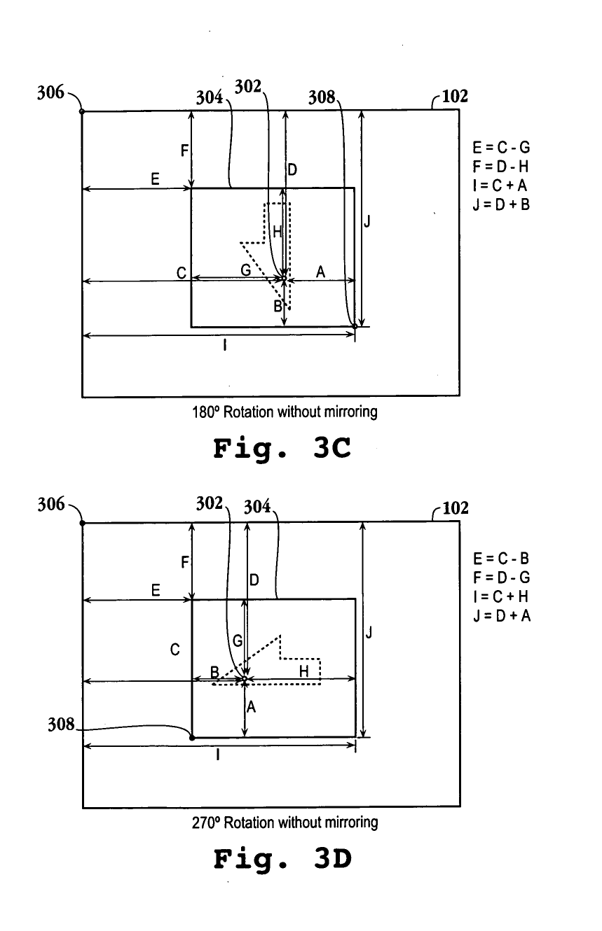

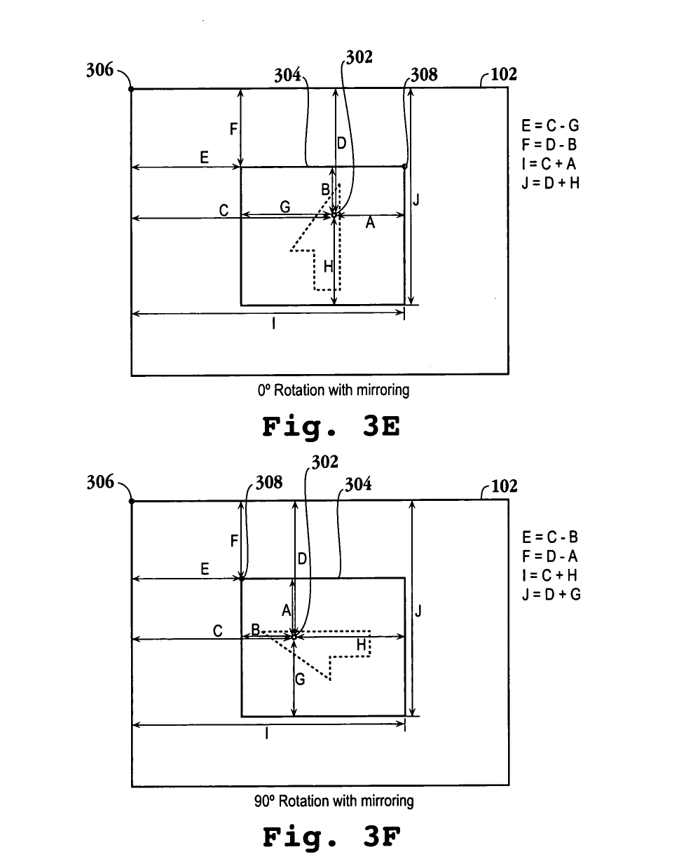

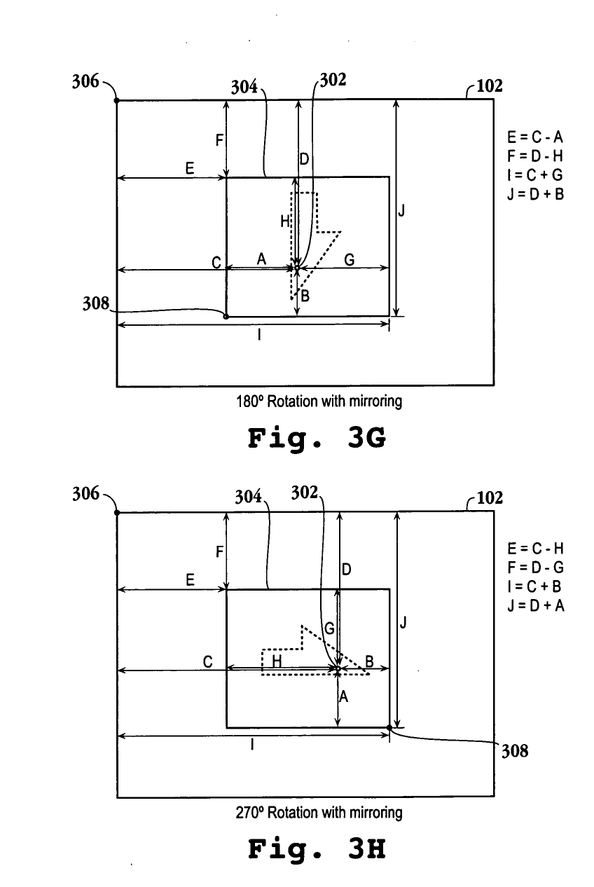

FIGS. 3A-3H are simplified schematic diagrams of dimensions used in the calculation of a position of the image after rotation about a user defined reference point, in accordance with one embodiment of the present invention. As discussed above, after a user defines a reference point, the position of the image is first calculated. As shown in FIGS. 3A-3H, display 102 includes image 304 of a half arrow. User defined reference point 302 is located within image 304. FIG. 3A shows an image 304 of the half arrow pointing up and the image is neither rotated nor mirrored. As used herein, mirroring is flipping the image about any axis. For instance, a mirrored image is flipped left to right or from right to left. In one embodiment, the position of image 304 relative to display 102 without rotation and without mirroring is calculated as follows:
X-start coordinate (E)=C−A;
Y-start coordinate (F)=D−B;
X-end coordinate (I)=C+G; and
Y-end coordinate (J)=D+H.
As shown in FIG. 3A,
A represents an X offset of user defined reference point 302 relative to upper left corner 308 of image 304.
B represents a Y offset of user defined reference point 302 relative to upper left corner 308 of image 304.
C represents an X offset of image position relative to upper left corner 306 of display 102.
D represents a Y offset of image position relative to upper left corner 306 of display 102.
G represents A subtracted from a width of image 304 (i.e., a distance between user defined reference point 302 and a right side of image 304).
H represents B subtracted from a height of image 304 (i.e., a distance between user defined reference point 302 and a bottom side of image 304).
   The dimensions (i.e., A, B, C, etc.) described above are referenced to upper left corner 308 of image 304 and upper left corner 306 of display 102. However, the dimensions may be referenced to any suitable point within image 304 and display 102. Other exemplary embodiments of reference points may include an upper right corner of display 102, a bottom left corner of the display, a bottom right corner of the display, an upper right corner of image 304, a bottom left corner of the image, and a bottom right corner of the image.

FIG. 3B shows a position of image 304 after a ninety degrees rotation about user defined reference point 302 without mirroring. As shown in FIG. 3B, half arrow is pointing to the right after the rotation. In one embodiment, the position of image 304 relative to display 102 after the ninety degrees rotation is calculated as follows:
X-start coordinate (E)=C−H;
Y-start coordinate (F)=D−A;
X-end coordinate (I)=C+B; and
Y-end coordinate (J)=D+G.

FIG. 3C shows a position of image 304 after a 180 degrees rotation about user defined reference point 302 without mirroring. As shown in FIG. 3C, half arrow is pointing down after the rotation. In one embodiment, the position of image 304 relative to display 102 after the 180 degrees rotation is calculated as follows:
X-start coordinate (E)=C−;
Y-start coordinate (F)=D−H;
X-end coordinate (I)=C+A; and
Y-end coordinate (J)=D+B.

FIG. 3D shows a position of image 304 after a 270 degrees rotation about user defined reference point 302 without mirroring. As shown in FIG. 3D, half arrow is pointing to the left after the rotation. In one embodiment, the position of image 304 relative to display 102 after the 270 degrees rotation is calculated as follows:
X-start coordinate (E)=C−B;
Y-start coordinate (F)=D−G;
X-end coordinate (I)=C+H; and
Y-end coordinate (J)=D+A.

FIG. 3E shows a position of image 304 without rotation but with mirroring. As shown in FIG. 3E, half arrow is pointing up but image 304 of the half arrow is flipped from right to left. In one embodiment, the position of image 304 relative to display 102 is calculated as follows:
X-start coordinate (E)=C−G;
Y-start coordinate (F)=D−B;
X-end coordinate (I)=C+A; and
Y-end coordinate (J)=D+H.

FIG. 3F shows a position of image 304 after a ninety degrees rotation about user defined reference point 302 with mirroring. As shown in FIG. 3F, half arrow is pointing to the left after the rotation. In one embodiment, the position of image 304 relative to display 102 after the ninety degrees rotation is calculated as follows:
X-start coordinate (E)=C−B;
Y-start coordinate (F)=D−A;
X-end coordinate (I)=C+H; and
Y-end coordinate (J)=D+G.

FIG. 3G shows a position of image 304 after a 180 degrees rotation about user defined reference point 302 with mirroring. As shown in FIG. 3G, half arrow is pointing down after the rotation. In one embodiment, the position of image 304 relative to display 102 after the 180 degrees rotation is calculated as follows:
X-start coordinate (E)=C−A;
Y-start coordinate (F)=D−H;
X-end coordinate (I)=C+G; and
Y-end coordinate (J)=D+B.

Finally, FIG. 3H shows a position of image 304 after a 270 degrees rotation about user defined reference point 302 with mirroring. As shown in FIG. 3H, half arrow is pointing to the right after the rotation. In one embodiment, the position of image 304 relative to display 102 after the 270 degrees rotation is calculated as follows:
X-start coordinate (E)=C−H;
Y-start coordinate (F)=D−G;
X-end coordinate (I)=C+B; and
Y-end coordinate (J)=D+A.

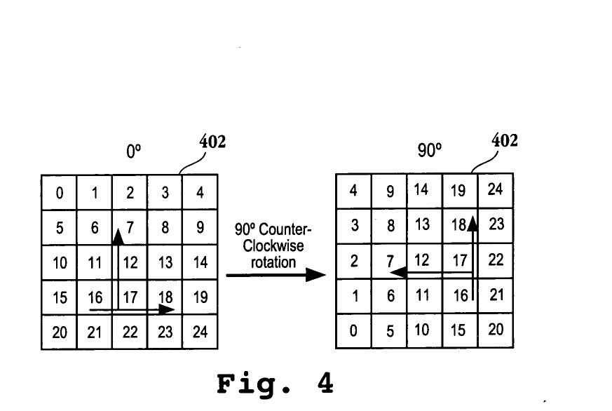

After the position is calculated, an order to fetch image pixels from memory is calculated. FIG. 4 is a simplified diagram illustrating the order of memory addresses being fetched when an image is rotated ninety degrees about a user defined reference point, in accordance with one embodiment of the present invention. For illustrative purposes, each square within image 402 represents a pixel. Each number (e.g., 1, 2, 3, 4, etc.) within the square represents a memory address associated with the pixel. The memory address is a number assigned to each pixel that is used to track where each pixel is stored in memory. The memory address can be any suitable bit-width. For example, in one embodiment, the memory address is eight bits in length. In another embodiment, the memory address is sixteen bits in length.

As shown in FIG. 4, twenty five squares (i.e., 5×5 array of pixels) comprise image 402. Each pixel is associated with a memory address number. For instance, at zero degrees rotation, a pixel positioned at the top left hand corner of image 402 has a memory address represented by zero and another pixel positioned at the top right hand corner of the image has a memory address represented by four.

In this case, the particular order in which the pixels are fetched from memory defines the rotation of image 402. In other words, image 402 is rotated by associating a pixel position with different memory addresses. For instance, as shown in FIG. 4, image 402 is rotated ninety degrees about a user defined reference point located at the center of the image. At zero degree rotation, the pixel positioned at the top left hand corner of image 402 is associated with the memory address of zero. After a ninety degrees counterclockwise rotation, the same pixel positioned at the top left hand corner of image 402 is associated with a different memory address of four. Consequently, at zero degree rotation, the pixels that comprise a top, horizontal line of image 402 are fetched from left to right in order from memory addresses 0, 1, 2, 3, and 4. To rotate image 402 ninety degrees counterclockwise, pixels that comprise the top, horizontal line of image 402 are instead fetched from left to right in order from memory addresses 4, 9, 14, 19, and 24. It should be appreciated that the data in memory does not change, but the fetch order of the data from memory changes.

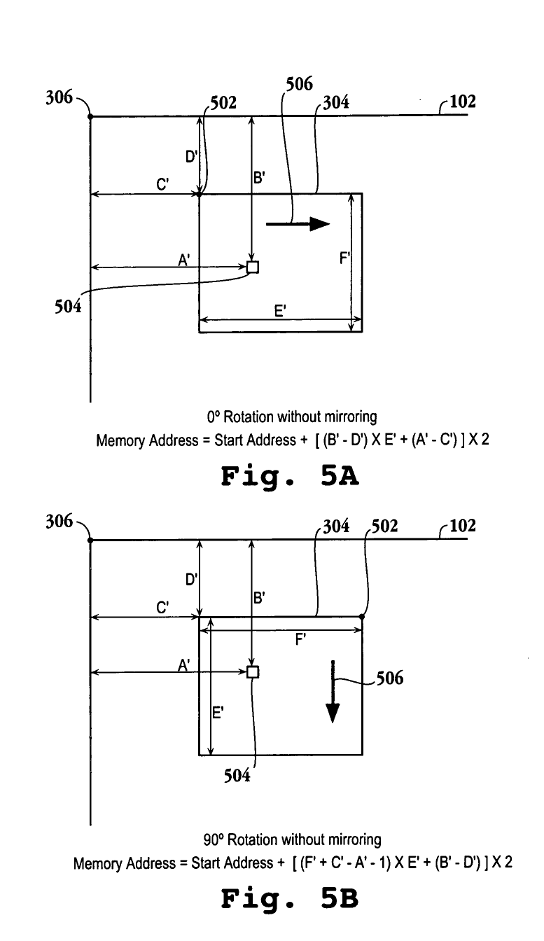

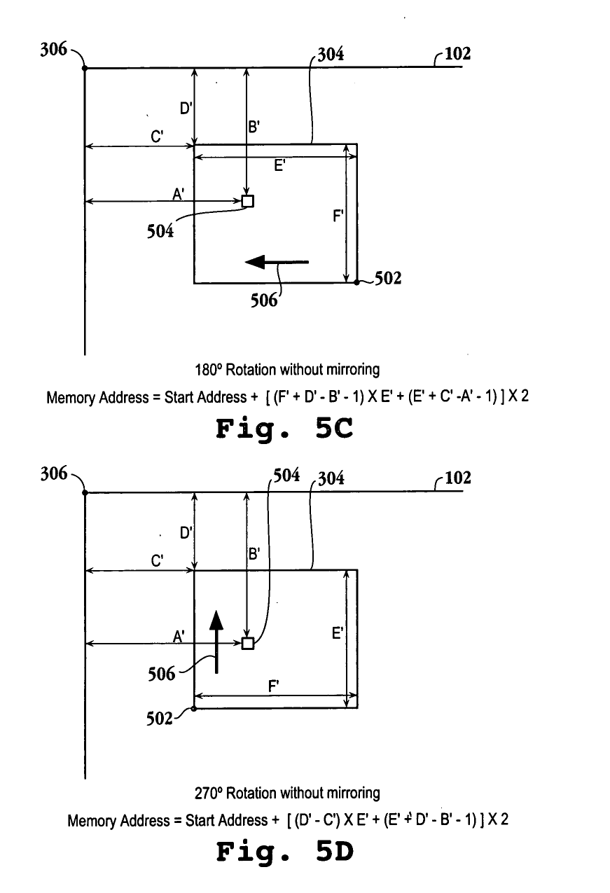

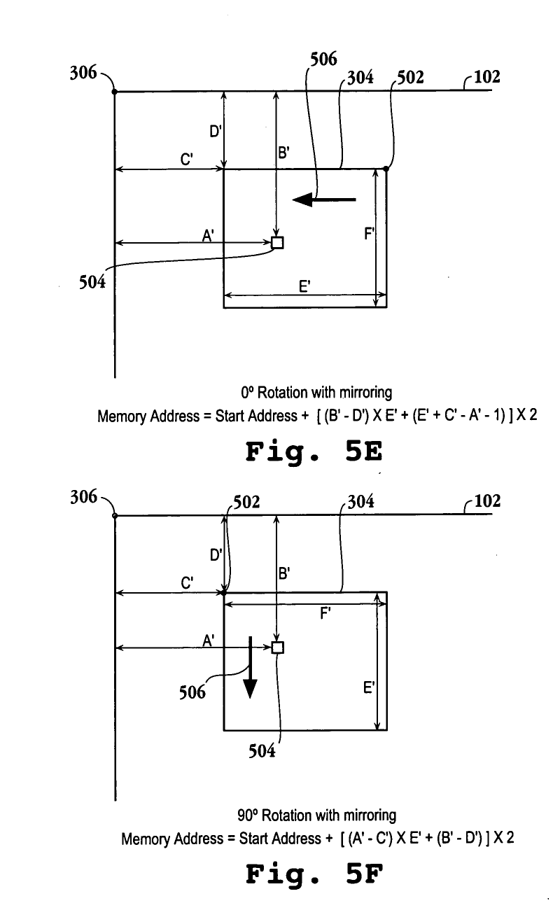

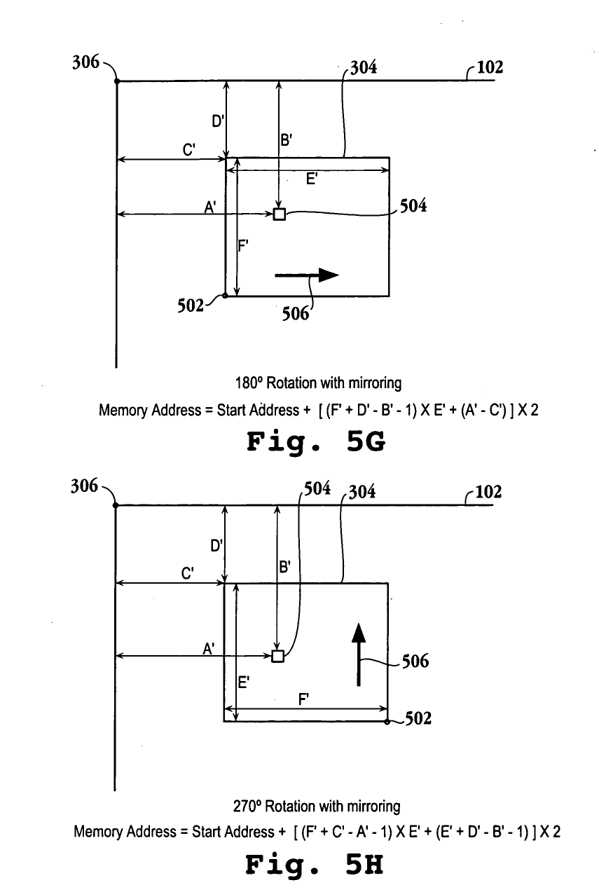

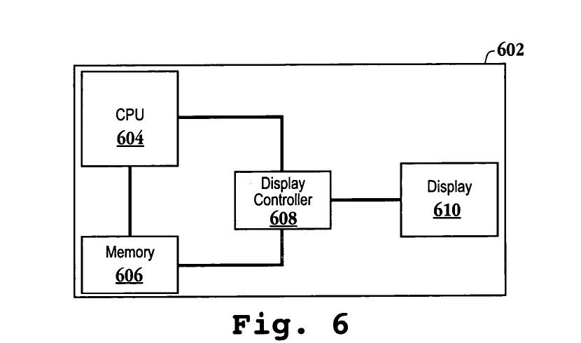

FIGS. 5A-5H are simplified schematic diagrams of dimensions used in the calculation of memory addresses to fetch particular pixel positions to rotate an image, in accordance with one embodiment of the present invention. FIGS. 5A-5H show image 304 within display 102. A pixel is located at pixel position 504 within image 304. The figures also show location of start address 502 and direction of increasing memory address 506. In one embodiment, start addresses 502 for various rotations are calculated as follows:
Start address for zero degree rotation=Start address;
Start address for ninety degrees rotation=Start address+(a width of image−1);
Start address for 180 degrees rotation=Start address+[(the width of image*the height of image)−1]; and
Start address for 270 degrees rotation=Start address+[the width of image*(the height of image−1)].
For example, as shown in FIG. 4, the start address for zero degree rotation is zero. On the other hand, the start address for ninety degrees rotation is four. Returning to FIGS. 5A-5H, direction of increasing memory address 506 shows a read sequence of memory addresses by a display pipe after the rotation and mirroring. In effect, direction of increasing memory address 506 shows the original memory address mapping before the rotation. For instance, the direction of increasing memory address in FIG. 4 for ninety degrees rotation points from left to right and, for a top horizontal line, the display pipe reads memory addresses from a sequence of 4, 9, 14, and 24.

As shown in FIG. 5A, image 304 is not rotated and not mirrored. In one embodiment, a memory address at pixel location 504 without rotation and without mirroring is calculated as follows:
Memory Address=Start Address+[(B′−D′)*E′+(A′−C′)]*2.
As shown in FIG. 5A,
A′ represents an X pixel position relative to upper left corner 306 of display 102.
B′ represents a Y pixel position relative to upper left corner 306 of display 102.
C′ represents a calculated X-start coordinate relative to upper left corner 306 of display 102.
D′ represents a calculated Y-start coordinate relative to upper left corner 306 of display 102.
E′ represents a width of image 304.
   The dimensions (i.e., A′, B′, C′, etc.) described above are referenced to upper left corner 306 of display 102. However, the dimensions may be referenced to any suitable point within display 102. Other exemplary embodiments of reference points include an upper right corner of display 102, a bottom left corner of the display, and a bottom right corner of the display.

FIG. 5B shows image 304 rotated ninety degrees without mirroring. In one embodiment, a memory address at pixel location 504 of image 304 rotated ninety degrees without mirroring is calculated as follows:
Memory Address=Start Address+[(F′+C′−A′−1)*E′+(B′−D′)]*2.
As shown in FIG. 5B,
F′ represents a height of image 304.

FIG. 5C shows image 304 rotated 180 degrees without mirroring. As shown in FIG. 5C, in one embodiment, the memory address at pixel location 504 of image 304 rotated 180 degrees without mirroring is calculated as follows:
Memory Address=Start Address+[(F′+D′−B′−1)*E′+(E′+C′−A′−1)]*2

FIG. 5D shows image 304 rotated 270 degrees without mirroring. As shown in FIG. 5D, in one embodiment, the memory address at pixel location 504 of image 304 rotated 270 degrees without mirroring is calculated as follows:
Memory Address=Start Address+[(D′−C′)*E′+(E′+D′−B′−1)]*2

FIG. 5E shows image 304 image not rotated with mirroring. As shown in FIG. 5E, in one embodiment, the memory address at pixel location 504 of image 304 not rotated with mirroring is calculated as follows:
Memory Address=Start Address+[(B′−D′)*E′+(E′+C′−A′−1)]*2

FIG. 5F shows image 304 rotated ninety degrees with mirroring. As shown in FIG. 5F, in one embodiment, the memory address at pixel location 504 of image 304 rotated ninety degrees with mirroring is calculated as follows:
Memory Address=Start Address+[(A′−C′)*E′+(B′−D′)]*2

FIG. 5G shows image 304 rotated 180 degrees with mirroring. As shown in FIG. 5G, in one embodiment, the memory address at pixel location 504 of image 304 rotated 180 degrees with mirroring is calculated as follows:
Memory Address=Start Address+[(F′+D′−B′−1)*E′+(A′−C′)]*2

Finally, FIG. 5H shows image 304 rotated 270 degrees with mirroring. As shown in FIG. 5H, in one embodiment, the memory address at pixel location 504 of image 304 rotated 270 degrees with mirroring is calculated as follows:
Memory Address=Start Address+[(F′+C′−A′−1)*E′+(E′+D′−B′−1)]*2

FIG. 6 is a simplified schematic diagram of an apparatus for rotating an image about a user defined reference point, in accordance with one embodiment of the present invention. Apparatus 602 includes any suitable type of computing device. For example, apparatus 602 may be a personal digital assistant, a cell phone, web tablet, packet personal computer, etc. As shown in FIG. 6, apparatus 602 includes central processing unit (CPU) 604, memory 606, display controller 608, and display 610. Display 610 may include liquid crystal (LCD) displays, thin-film transistor (TFT) displays, cathode ray tube (CRT) monitors, televisions, etc. Examples of memory 606 include static access memory (SRAM), dynamic random access memory (DRAM), etc.

Display controller 608 is coupled to CPU 604, memory 606, and display 610. In one embodiment, CPU 604 contains instructions to process a user defined reference point and instructions to transmit the user defined reference point to display controller 608. Memory 606 stores image pixels. However, in another embodiment, image pixels are instead stored in a memory included within display controller 608. One skilled in the art will appreciate that while CPU 604, memory 606, and display controller 608 are illustrated as being interconnected, each of these components may be in communication with a common bus to enable communication between the components.

The functionality described for a rotation of an image about the user defined reference point is incorporated into display controller 608. In one embodiment, display controller 608 contains the circuitry for calculating the position of the image, calculating an order to fetch the image pixels from the memory, and fetching the image pixels from memory 606 according to the calculated order. Display 610 coupled to display controller 608 then displays the rotated image. It will be apparent to one skilled in the art that the functionality described herein may be synthesized into firmware through a suitable hardware description language (HDL). For example, the HDL (e.g., VERILOG) may be employed to synthesize the firmware and the layout of the logic gates for providing the necessary functionality described herein to provide a hardware implementation of the image rotation techniques and associated functionalities. Thus, the embodiments described herein may be captured in any suitable form or format that accomplishes the functionality described herein and is not limited to a particular form or format.

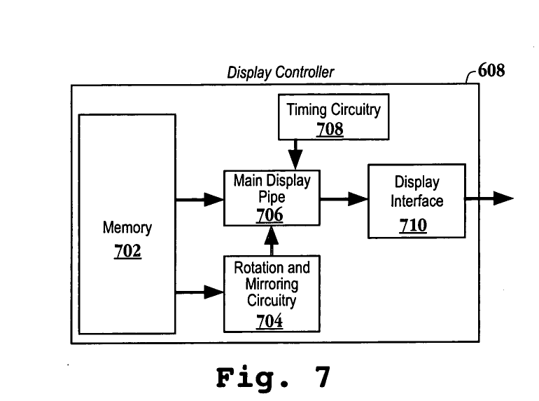

FIG. 7 is a more detailed schematic diagram of the display controller shown in FIG. 6, in accordance with one embodiment of the present invention. As shown in FIG. 7, display controller 608 includes memory 702, main display pipe 706, timing circuitry 708, display interface 710, and rotation and mirroring circuitry 704. Memory 702 included within display controller 608 stores image pixels and main display pipe 706 fetches the stored image pixels from the memory. Additionally, timing circuitry 708 is in communication with main display pipe 706 and generates horizontal display enable (Hde) and vertical display enable (Vde) signals, which basically provides timing control signals to the main display pipe. Display interface 710 which is coupled to main display pipe 706 provides an interface to a display.

Rotation and mirroring circuitry 704 includes the logic to calculate the position of the image and provides an order to fetch image pixels from memory 702. For example, in one embodiment, rotation and mirroring circuitry 704 includes hardware implemented logic for receiving the user defined reference point, calculating a position of the image, and calculating the order to fetch image pixels from memory 702. The functionality described for the rotation of the image about the user defined reference point is not limited to rotation and mirroring circuitry 704, but may be incorporated into any suitable parts of display controller 608. For example, in another embodiment, the hardware implemented logic described above may be incorporated into main display pipe 706.

In summary, the above described invention provides an apparatus, a display controller, and hardware implemented methods to rotate an image about a user defined reference point. When compared to the conventional software calculations to rotate an image, calculating an order to fetch image pixels from the memory to rotate the image instead is much faster, simpler to calculate, and requires less processing power. As a result, small, portable devices with limited power, memory, and computing capability incorporating the above described invention can adequately process and animate the images.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

1. A hardware implemented method for rotating an image about a user defined reference point, comprising the method operations of:
receiving the user defined reference point, the user defined reference point capable of being defined outside the image;
calculating a position of the image, the position defining a location of the image after rotation about the user defined reference point;
calculating an order to fetch one or more image pixels from memory, the order defining a rotation of the image after rotation about the user defined reference point; and
fetching the image pixels from the memory according to the calculated order.

2. The hardware implemented method of claim 1, further comprising:
displaying the fetched image pixels at the calculated position.

3. The hardware implemented method of claim 1, wherein the image is a portion of a larger image.

4. The hardware implemented method of claim 1, wherein the image is a sprite.

5. The hardware implemented method of claim 1, wherein the method operation of calculating the position of the image includes,
calculating an X-start coordinate, the X-start coordinate being defined by subtracting an X offset of the user defined reference point relative to an upper left corner of the image from an X offset of an image position relative to an upper left corner of a display;
calculating a Y-start coordinate, the Y-start coordinate being defined by subtracting a Y offset of the user defined reference point relative to the upper left corner of the image from a Y offset of the image position relative to the upper left corner of the display;
calculating an X-end coordinate, the X-end coordinate being defined by adding the X offset of the image position relative to the upper left corner of the display and a distance between the user defined reference point and a right side of the image; and
calculating a Y-end coordinate, the Y-end coordinate being defined by adding the Y offset of the image position relative to the upper left corner of the display and a distance between the user defined reference point and a bottom side of the image,
wherein the image is not rotated without mirroring about the user defined reference point.

6. The hardware implemented method of claim 1, wherein the method operation of calculating the position of the image includes,
calculating an X-start coordinate, the X-start coordinate being defined by subtracting a distance between the user defined reference point and a bottom side of the image from an X offset of the image position relative to an upper left corner of a display;
calculating a Y-start coordinate, the Y-start coordinate being defined by subtracting an X offset of the user defined reference point relative to an upper left corner of the image from a Y offset of the image position relative to the upper left corner of the display;
calculating an X-end coordinate, the X-end coordinate being defined by adding the X offset of the image position relative to an upper left corner of a display and a Y offset of the user defined reference point relative to the upper left corner of the image; and
calculating a Y-end coordinate, the Y-end coordinate being defined by adding the Y offset of the image position relative to the upper left corner of the display and a distance between the user defined reference point and a right side of the image,
wherein the image is rotated ninety degrees without mirroring about the user defined reference point.

7. The hardware implemented method of claim 1, wherein the method operation of calculating the position of the image includes,
calculating an X-start coordinate, the X-start coordinate being defined by subtracting an X offset of the user defined reference point relative to an upper left corner of the image from an X offset of the image position relative to an upper left corner of a display;
calculating a Y-start coordinate, the Y-start coordinate being defined by subtracting a distance between the user defined reference point and a bottom side of the image from a Y offset of the image position relative to the upper left corner of the display;
calculating an X-end coordinate, the X-end coordinate being defined by adding the X offset of the image position relative to the upper left corner of the display and a distance between the user defined reference point and a right side of the image; and
calculating a Y-end coordinate, the Y-end coordinate being defined by adding the Y offset of the image position relative to the upper left corner of the display and a Y offset of the user defined reference point relative to the upper left corner of the image,
wherein the image is rotated 180 degrees with mirroring about the user defined reference point.

8. The hardware implemented method of claim 1, wherein the method operation of calculating the position of the image includes,
calculating an X-start coordinate, the X-start coordinate being defined by subtracting a distance between the user defined reference point and a bottom side of the image from an X offset of the image position relative to an upper left corner of a display;
calculating a Y-start coordinate, the Y-start coordinate being defined by subtracting a distance between the user defined reference point and a right side of the image from a Y offset of the image position relative to the upper left corner of the display;
calculating an X-end coordinate, the X-end coordinate being defined by adding the X offset of the image position relative to the upper left corner of the display and a Y offset of the user defined reference point relative to an upper left corner of the image; and
calculating a Y-end coordinate, the Y-end coordinate being defined by adding the Y offset of the image position relative to the upper left corner of the display and an X offset of the user defined reference point relative to the upper left corner of the image,
wherein the image is rotated 270 degrees with mirroring about the user defined reference point.

9. The hardware implemented method of claim 1, wherein the method operation of calculating the order to fetch the image pixels from the memory includes,
associating a pixel position of the image with a memory address of the image pixel stored in the memory, the association defining a rotation of the image after rotation about the user defined reference point.

10. The hardware implemented method of claim 9, wherein the method operation of associating the pixel position of the image with the memory address of the image pixel stored in the memory includes,
calculating the memory address to fetch at the pixel location, the memory address being defined by
a start address+[(F′+D′−B′−1)*E′+(E′+C′−A′−1)]*2,
wherein the image is rotated 180 degrees without mirroring about the user defined reference point.

11. The hardware implemented method of claim 10, wherein
the A′ represents an X pixel position relative to an upper left corner of a display;
the B′ represents a Y pixel position relative to the upper left corner of the display;
the C′ represents a calculated X-start coordinate relative to the upper left corner of the display;
the D′ represents a calculated Y-start coordinate relative to the upper left corner of the display;
the E′ represents a width of the image; and
the F′ represents a height of the image.

12. The hardware implemented method of claim 9, wherein the method operation of associating the pixel position of the image with the memory address of the image pixel stored in the memory includes,
calculating the memory address to fetch at the pixel location, the memory address being defined by
a start address+[(D′−C′)*E′+(E′+D′−B′−1)]*2,
wherein the image is rotated 270 degrees without mirroring about the user defined reference point.

13. The hardware implemented method of claim 9, wherein the method operation of associating the pixel position of the image with the memory address of the image pixel stored in the memory includes,
calculating the memory address to fetch at the pixel location, the memory address being defined by
a start address+[(B′−D′)*E′+(E′+C′−A′−1)]*2,
wherein the image is not rotated with mirroring about the user defined reference point.

14. The hardware implemented method of claim 9, wherein the method operation of associating the pixel position of the image with the memory address of the image pixel stored in the memory includes,
calculating the memory address to fetch at the pixel location, the memory address being defined by
a start address+[(A′−C′)*E′+(B′−D′)]*2,
wherein the image is rotated ninety degrees with mirroring about the user defined reference point.

15. A display controller for rotating an image about a user defined reference point, comprising:
a memory configured to store image pixels;
a main display pipe configured to fetch the stored image pixels from the memory; and
a rotation and mirroring circuitry coupled to the main display pipe configured to calculate the rotation of the image about the user defined reference point, the rotation and mirroring circuitry including,
logic for receiving the user defined reference point,
logic for calculating a position of the image, the position defining a location of the image after rotation about the user defined reference point, and
logic for calculating an order to fetch the image pixels from the memory, the order defining a rotation of the image after rotation about the user defined reference point.

16. The display controller of claim 15, further comprising:
a display interface coupled to the main display pipe, the display interface being configured to interface with a display; and
a timing circuitry coupled to the main display pipe, the timing circuitry being configured to provide timing control signals to the main display pipe.

17. The display controller of claim 15, wherein the user defined reference point is capable of being defined outside the image.

18. The display controller of claim 15, wherein the memory is selected from the group consisting of a static random access memory (SRAM) and a dynamic random access memory (DRAM).

19. The display controller of claim 15, wherein the image is a portion of a larger image.

20. The display controller of claim 15, wherein the image is a sprite.

21. The display controller of claim 20, wherein the sprite is an animated graphic image in a larger graphic image.

22. The display controller of claim 15, wherein the logic is hardware implemented.

23. An apparatus for rotating an image about a user defined reference point, comprising:
a display controller including,
circuitry for calculating a position of the image, the position defining a location of the image after rotation about the user defined reference point,
circuitry for calculating an order to fetch image pixels from a memory configured to store image pixels, the order defining a rotation of the image after rotation about the user defined reference point, and
circuitry for fetching the image pixels from the memory according to the calculated order;
a central processing unit (CPU), the CPU containing instructions to process the user defined reference point and to transmit the user defined reference point to the display controller; and
a display coupled to the display controller, the display enabling the display of the rotated image.

24. The apparatus of claim 23, wherein the user defined reference point is capable of being defined outside the image.

25. The apparatus of claim 23, wherein the image is a portion of the display.

26. The apparatus of claim 23, wherein the image is a sprite.

27. The apparatus of claim 26, wherein the sprite is an animated graphic image in the display.

28. The apparatus of claim 23, wherein the display is selected from the group consisting of a liquid crystal display (LCD), a thin-film transistor (TFT) display, a cathode ray tube (CRT) monitor, and a television.

29. The apparatus of claim 23, wherein the memory is selected from the group consisting of a static random access memory (SRAM) and a dynamic random access memory (DRAM).
